(19) United States
(12) Patent Application Publication
(10) Pub. No.: US 2007/0186006 A1
(43) Pub. Date: Aug. 9, 2007

(54) Systems and Methods for Creation and Use of a Timeline of Broadcast Streaming Media Programs

(76) Inventor: Frank H. Murray, Greenwich, CT (US)

Correspondence Address: BROMBERG & SUNSTEIN LLP, 125 SUMMER STREET, BOSTON, MA, 02110-1618, US

(21) Appl. No.: 11/668,290

(22) Filed: Jan. 29, 2007

Related U.S. Application Data
(60) Provisional application No. 60/763,065, filed on Jan. 27, 2006.

(51) Int. Cl. G06F 15/16

(52) U.S. Cl. 709/231

(57) ABSTRACT

Systems and methods for controlling broadcast streaming media to a user's Internet-accessible device are disclosed. In one embodiment, a timeline temporally associating streaming media content programs from a plurality of Internet resources is created and sent to a server. After receiving a playback request form a user's device, the server accesses the timeline and identifies the address associated with a streaming media content program for the current time as indicated in the timeline. The server then sends across the Internet to the user's device the address of the program associated with the current time on the timeline. The user's device then accesses the broadcast streaming program and playback begins. At subsequent times, according to the timeline, the server will send a new address to the user's device that is indicative a program within the timeline. Thus, playback on the user's device is continuous and changes automatically according to the user's preferences as indicated in the timeline.

### PRIORITY

The present application claims priority from U.S. provisional patent application 60/763,065 entitled “Systems and Methods for Time-Based Creation of Individual Playlists for Live Audio Delivered over the Internet” filed on Jan. 27, 2006 that is incorporated herein by reference in its entirety.

### TECHNICAL FIELD AND BACKGROUND ART

The present invention relates to delivering streaming media programs through the Internet to a user's device, such as a computer. In particular, the present invention relates to individualized creation of a timeline for automatic switching between broadcast streaming Internet programs.

People have numerous options for listening to live audio. These include terrestrially based broadcast radio, satellite broadcast radio, Internet transmitted audio, cable system music stations and other means. Furthermore, the options for receiving such audio are numerous and include broadcast radio receivers, computers, cell phones, satellite radios, satellite dishes, cable boxes and the like.

Typically, an individual must manually change the settings on their receiving device to vary what they are listening to. For instance, while sitting at a desk, an individual may have a radio that requires the individual to manually change the station to which the radio is tuned in order to change what programming is being received. Of course, broadcast radio is spatially limited and an individual, therefore, may only receive and listen to programs that are being broadcast from a station that is relatively close to the individual.

The Internet, however, does not have such spatial limitation. Indeed, an individual using an Internet connection may “tune in” to radio stations anywhere in the world as long as the station broadcasts its content over the Internet. The individual must still, however, manually select the station they wish to listen to by utilizing, for example, computer based media players such as Windows Media Player, Quicktime or Real Player or by going to the website for a particular radio station causing a JavaScript to be run. To this end, the individual must still operate the computer in much the same way the individual would a traditional radio, by moving between web-sites (or locations) until finding programming that interests the individual.

Some options do, however, allow for the listener to select programs in advance that suit their preferences. One example is a satellite radio system where an individual may schedule recording of a program that the listener wants to hear at a future time. The recording schedule is saved in a local device (a satellite radio receiver) and the local device tunes the receiver and records the scheduled event at the appropriate time. One problem with this construction comes if the listener does not have use of the receiving device for any numerous reasons. Perhaps the listener left the receiver behind, or lost the receiver or perhaps the receiver malfunctions. Under any of these scenarios the recorded program will not be available to the listener.

In addition, this mechanism also does not allow for listeners to pre-determine when they listen to certain streaming radio programs that are broadcast at different times from different media sources. A listener may like certain types of programs, but have a strong preference for when they hear a program. For example, a listener may like loud music, but not want to hear such music in the mornings. For example, a listener may wish to hear a particular program but only hear a portion of the program that fits their listening preferences for their own local time zone.

### SUMMARY OF THE INVENTION

Embodiments of the present invention allow a user to create an Internet-based time-sequence timeline selected from a plurality of Internet-streamed broadcasts from a plurality of media sources. The timeline is defined by the user who selects such broadcast programs at different times for continuous playback, so that the user can listen or watch broadcast content wherein the content is automatically switched between programs as designated in the timeline. A separate timeline can be created for each day of the week or different programming tastes. For example, a user can create genre-based timelines for talk shows, comedy programming, different musical styles or any combination thereof The result is a custom-built, time-based daily sequence of broadcast programs. The timeline is provided to a timeline server that stores the timeline in a database. When a user indicates that the user wishes to have access to the content from a timeline, the user contacts the timeline server which in turn sends an address, such as a URL, along with all or a portion of the user's timeline information, to the user's device. The user's device using JavaScript, Ajax or similar scripting languages automatically switches to the broadcast program for the current time as indicated in the user's timeline and the stream is received from the media source. The user's device using JavaScript, Ajax or similar scripting languages and the timeline server information will then request and receive subsequent addresses for new broadcast content each time a new start time occurs as indicated in the user's timeline.

### BRIEF DESCRIPTION OF THE DRAWINGS

The foregoing features of the invention will be more readily understood by reference to the following detailed description, taken with reference to the accompanying drawings, in which:

FIG. 1 graphically shows an example of a system that allows a user to schedule and playback broadcast streaming media programs from a plurality of media sources by time and or program;

FIG. 2A is a flow chart of events that occur on a timeline server;

FIG. 2B is a flow chart teaching the use by the timeline server of upcoming program information from a media source;

FIG. 3A is a flow chart of events that occur on a user device;

FIG. 3B is a flow chart that teaches the events that occur on a user device when a new address is received from a timeline server for a new broadcast as designated in the user's timeline;

FIG. 4 is a screen shot showing an exemplary webpage for creation of a timeline and playback of broadcast streaming media content.

### DETAILED DESCRIPTION OF SPECIFIC EMBODIMENTS

Definitions. As used in this description and the accompanying claims, the following terms shall have the meanings indicated, unless the context otherwise requires: the term “timeline” refers to data indicative of broadcast streaming media programs selected by a user from a plurality of different media sources along with at least the desired start time for accessing each media source. For example, each of the media sources may be an Internet radio station or broadcast radio station that broadcasts streaming content via the Internet. Each radio station defines a schedule of broadcast streaming audio programs wherein each program is associated with a time period. Thus, different streaming radio stations generally have different programs (although some radio stations may broadcast the same program at the same time) being streamed at the same time. As used herein the term “publicly accessible” refers to the ability of any member of the public to access the broadcast streaming media content. Content that simply requires a password to access the content or requires payment in order to access the content is still publicly accessible. The term “Internet resource” shall refer to any device or file that is accessible through the Internet. For example, an Internet resource may be a content server/media source that provides content to a requesting user or an Internet resource may refer to a web page or the file and data that forms the web page. The term “address” shall refer to information that provides the location of a file or webpage in the Internet. Examples of addresses are URLs (universal resource locators), web address (www.yahoo.com), IP addresses and hyperlinks. The term “broadcast streaming media” refers to media provided by a broadcast source, such as a radio or television station that has a program schedule and not to on-demand streaming content. On-demand content begins only when a user makes a request for the content and therefore has a defined starting point whereas broadcast streaming media is accessed at a point in the changing stream.

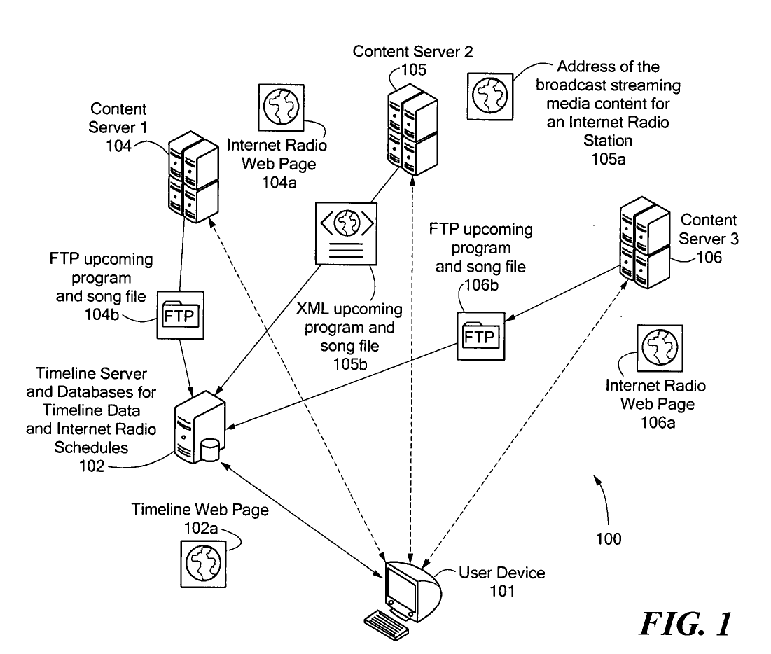

FIG. 1 shows an example of a system 100 that allows a user to schedule and playback of broadcast streaming media content from a plurality of media sources 104-106 by time and or program. Although many of the examples within the detailed description are directed to broadcast streaming audio, other broadcast streaming media types may be used with the present invention including broadcast streaming video. Similarly, the examples provided within this detailed description refer to JavaScripts that are provided within a webpage that are interpreted on a user's device and perform certain tasks. The present invention may use any mechanism including scripts, such as Perl and Ajax and program calls to executable programs to implement the same functionality.

A user accesses an Internet resource, such as a timeline server 102, using a user device 101 and requests retrieval of a timeline web page 102a (also an Internet resource). In response to the request, the timeline server sends the web page 102a and certain timeline information to the user's device. A user account may be created actively by a user signing up with user-provided information or an account can be created anonymously via a cookie. An account is created on a server using a unique cookie ID (which is also placed on the user's computer) which may be used to track the user's preferences. After the creation of a user account either actively or anonymously, the user can then define one or more personal schedules of broadcast streaming media for playback on the user's device 101. As used herein, a user device 101 refers to a device that is capable of displaying a web page, such as a computer, a cell phone, an Internet tablet or a personal digital assistant.

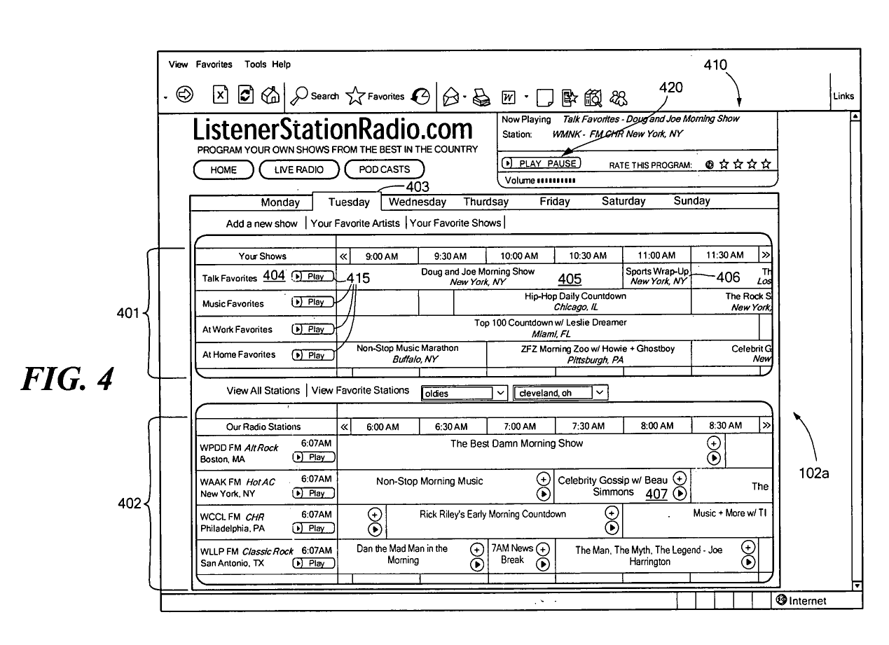

The timeline webpage 102a provides the user with a listing of schedule information for a plurality of broadcast media sources, such as Internet radio stations. An example of such a webpage is shown in FIG. 4. As shown, the webpage 102a displays the user created timelines 401 in the upper half of the webpage and a listing of streaming media schedules 402 in the bottom half of the web page. The timeline server 102 includes a database that stores the schedules for each broadcast streaming media program of each media source for which a user can create a timeline. Thus, prior to creation of a timeline, the timeline server 102 either queries or is sent the scheduling information. For example, the timeline server may receive the scheduling information for the upcoming week or month from a plurality of on-line Internet radio stations. A user can select a day of the week 403 and create a personalized schedule of programs or portions of programs. For example, as shown, in “Your Shows” 401 a user has created a timeline for Tuesday mornings for Talk Favorites 404 that includes the “Doug and Joe Morning Show” 405 that is to be streamed to the user's device 101 between at least 9:00 am and 11:00 am. This program or portion of the Doug and Joe Morning show is broadcast from an internet radio station located in New York and associated with a particular URL (Universal Resource Locator). At 11:00 am the user wishes to switch to another program entitled, “Sports Wrap up.” 406 Thus, at 11:00 am the user wishes to stop receiving the stream from the first content server broadcasting the Doug and Joe morning show 405 and connect to a second content server broadcasting the Sports Wrap Up show 406.

The process of creating the timeline can be accomplished through one or more pull-down menus or through a JavaScript such as an AJAX (asynchronous JavaScript and xml) script that allows for dragging and dropping of the desired programs from the media schedule to the personalized timeline. A user can select a complete broadcast streaming program (i.e. celebrity gossip 407 between 7:30-8:30 am) or a portion of a broadcast streaming program (i.e. celebrity gossip between 7:45-8:15 am). If a user does not create a timeline that is continuous and that has gaps, the timeline server 102 will first identify the gap and will ascertain a program that is being streamed from another media source 402 that is similar in scope (i.e. genre, content, location) to that of the previous or subsequent program to the gap and will fill in the gap with that program, unless the users specifies that they would prefer not to have such gaps filled automatically.

The web page 102a captures each of the user's selections for each timeline and associates the timeline data including the program information, day of the week and time period, with an identifier of the user. The web browser 410 transmits this information back either automatically using a script or at the request of the user to the timeline server 410. The timeline server 102 takes the timeline information received from the web browser 410, parses the information and places the information into a database, such as an SQL database for later retrieval.

The user may then request playback of a particular timeline. This would be accomplished by activating the “Play” button 415 for the timeline on the webpage. The play command would be transmitted to the timeline server with an identifier of the user and of the selected timeline. In response, the timeline server accesses the requested timeline in the database associated with the user. The timeline server also accesses a clock function or signal and determines the present time. In one embodiment, the clock is synchronized with a standard clock signal such as the National atomic clock or the NIST web clock. Based upon the present time determined by the clock signal, the timeline server identifies the program desired to be streamed to the user within the timeline, accesses the URL associated with the broadcast streaming media for the program, and then transmits the current time, the next pre-programmed start time, a stop connection command along with the URL back to the user's device as is known to those of ordinary skill in the art. The user's browser receives the stop playback command. Thus, if there is an audio stream already playing the command will cause a Media Player embedded in the webpage 420 or any other media player used by the broadcaster external to the browser to stop the stream. In the event, that the Internet radio station requires that a new browser window is opened and the stream to be played back in that browser window, a JavaScript within the main web page 102a (FIG. 4) will be executed to close the browser window for the Internet radio station. Once playback of any streaming media has ceased, a script within the web page 102a causes either a Java Media Player embedded in the webpage 420 or an external media player framed within a page of the site (i.e. Apple's Quicktime, Microsoft's Windows Media Player) to connect to the URL, open an embedded player and commence playing the media files.

In some embodiments, a user may create a timeline that includes alternative broadcast streaming media programs in the event that the user's first choice is cancelled or pre-empted. In such an embodiment, the timeline server either requests or is provided just prior to the beginning of a program, the upcoming programming information along with song information for the next several songs to be played. This information may be sent as an XML file 105b or may be sent via FTP 104b, 106b to the timeline server 102. The timeline server 102 includes logic that will parse and then compare the upcoming programming information to the program information within the user's timeline. If the user's timeline and the upcoming programming information differ, then the timeline server will default to the user's second choice.

In certain embodiments, prior to providing the user's second choice, the timeline server accesses its database that contains the programming schedules for each of the media sources and performs a search to see if another media source is streaming the same program. The timeline server can include functionality to locate identical programs that have an absolute start and end time that are identical to the user's first choice. If an identical program is located, the timeline server will send the URL for that program

If the timeline server does not locate the identical streaming media program that starts and ends at the same absolute time from a different media source, the timeline server will see if any other media sources are streaming the same program with different beginning and ending times that overlap with the user's timeline. The time line server will then forward the URL for the media source to the user's device so that the user's device switches to the new media server at the time designated for the program within the user's timeline. For example, if a user's timeline indicates that the user wishes to listen to program X (broadcast between 7 am-10 am) between the hours of 8 am-10 am from media source A and the show is preempted, the media server will identify media source B that broadcasts program X at a slightly later time, such as between 8 am-11 am and will switch to media source B at 8 am. In this configuration, it is preferable to cache a user's secondary choice so that the timeline server does not need to do an additional database search. Similarly, the URL's and associated start times for broadcast streaming media program within a timeline can be cached while the user maintains the connection with the website.

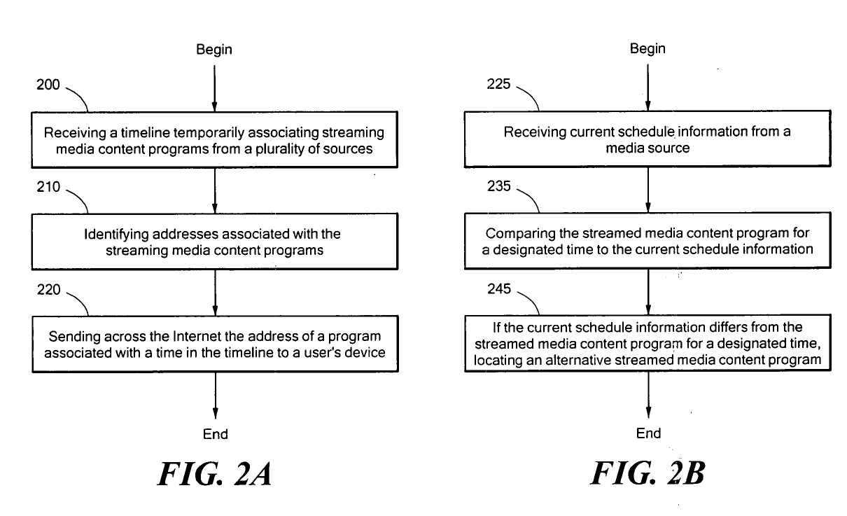

FIG. 2 is a flowchart of events that occur on the timeline server. The timeline server first receives through the Internet a request for the timeline webpage by a user's device. The user creates a timeline using the webpage and embedded tools (Ajax, JavaScript etc.) based upon the user's preferences and sends the timeline data to the timeline server along with a user identifier. The timeline server receives the timeline data that temporally associates streaming media content program titles 200. Thus, the timeline includes a temporally desired start-time for accessing the broadcast streaming media stream for a plurality of streaming media programs. The received timeline data may include for example: a user identifier followed by a day of the week, followed by a first start time, followed by a program name for a first program, followed by a second start time, followed by a second program name etc.

At some point after the creation of a user account and at least one timeline, the server receives either a user log-in request or information gathered from a cookie on the user's computer. In response, the server accesses the timeline database and queries the database based upon identification of the user to retrieve the timelines for the user. The server determines the present time and date at the server. The time can be identified by accessing an absolute source, such as the atomic clock. The server sends a new webpage or updates the old webpage to the user that includes each of the user's timelines for the appropriate day and time. This information may be cached in memory at the timeline server in order to provide quicker access to the timeline data without requiring a subsequent database look-up if the user switches between timeliness The server then will receive a play command from the user's device that selects a specific timeline. In response, the timeline server identifies the URL address associated with the current broadcast streaming media program within the selected user's timeline 210.

In other embodiments, the timeline server may identify all of the URL's of the broadcast streaming media programs within the time line as well as the specified start times and URL's for possible alternative programs in case a program is cancelled or pre-empted. Again, by caching the information for the user, the URL information for the broadcast streaming media programs is quickly accessible. Each program name within the timeline data and each timeline can include a unique identifier so that the appropriate radio station and address for the Internet radio station may be located through a database look-up. For example, the “At Works Favorites” timeline as shown in FIG. 4 may have an associated identifier timelineID=0002 and the “Top 100 Countdown” may have programID=1203. The association between the request for playing content from a specific timeline, the timeline data and the URLs for each program within the timeline data may be accomplished using techniques known by one of ordinary skill in the art. For example, the received play request from the user's device may contain the address/URL of each program or the play request may contain an identifier of the timeline wherein the timeline server would retrieve the URL in a database look-up. So if the user timeline server received timelineID=0002 and programID=1203, the timeline server could determine the media source that the user wishes to connect to.

Once the URL for the broadcast streaming media program is determined, the timeline server sends the address across the Internet to the user's device 220 along with updated timeline information including (among other things) the start time of the next program in the timeline. The web browser of the user or the media player of the user will be redirected to the URL. Thus, the web browser controls the redirecting of the user's device to the desired media source as defined in the user's timeline.

The JavaScript (or other scripting language) on the user's device will then periodically calculate the time and compare the time to user's timeline information. When the present time is within a few minutes of the scheduled start time for a different broadcast streaming media program, the JavaScript can request transmission of upcoming program information from the media source (content server) to check the response of such server and calculate the necessary time required to initiate transmission of the desired media. Using this calculated time, the JavaScript can then request transmission of current program information from the media source (content server) for the next broadcast streaming media program 225 as shown in FIG. 2B. The timeline server may obtain an FTP file or an XML file that contains the program information of the upcoming program and information regarding the present content being streamed along with the next one or two songs to be streamed.

The timeline server can then compare the upcoming program information with the next scheduled broadcast streaming media program within the user's presently selected timeline to confirm that they are indeed the same 235. If they differ, the timeline server will default to the user's second choice for a broadcast program 245 and send the revised information to the user's device. If the user has not included a second choice, the timeline server will access the database containing all of the program listings/schedules from the media sources and determine a comparable program and send the revised information to the user's device. For example, the timeline server may have logic that prefers programs of the same genre that start and end at substantially the same time as that of the user's first choice for broadcast streaming media. At the start time of the new broadcast streaming media program, the timeline server will transmit the new URL to the user's device.

The user's device will load the new URL accessing the stream at the URL address causing playback of the new broadcast streaming media program and stopping playback of the previous streaming media program.

In some embodiments, the timeline server may provide the entire timeline sequence and all of the addresses/URLs for the programs within the timeline to the user's device wherein the information is maintained by the web browser. In such an embodiment, the timeline server may send the current time to the user's web browser, and the timeline server may have limited subsequent interaction with the user's device. In such a configuration, the web page includes a JavaScript timer for keeping track of the time. Therefore, the timer identifies the start times for each of the programs within the timeline sequence. In order to guarantee that the user's device switches between broadcast streams according to the timeline, the timeline server may periodically receive a request through a JavaScript for the current time from the user's device in order to synchronize the timer. Additionally, the user's device may query if the timeline information has changed since it was first sent. If the timeline information has changed, the user's machine will request the information from the timeline server.

In certain embodiments, when the user accesses the timeline website, the user may be presented with the ability to enter artist and song preferences. This information is sent to the timeline web server and stored in a database that associates the information with the user identifier. As indicated above, the timeline server can obtain upcoming program information from a media source. Rather than querying only the media source for an upcoming program within a timeline, the timeline server may continually query each of the media sources that stream broadcasts and compile a table of each song that is being played or is about to be played. For example, the JavaScript can check the timeline server every 60 second to review upcoming program information and the timeline server can then compare the users preferred artists and songs to the upcoming songs and artists and can cause an update to the timeline webpage, querying the user if he wishes to change to another media source that will be broadcasting one of the user's preferred artists or songs.

If the user affirmatively indicates that he desires to switch between streaming sources, the timeline server will transmit the URL for the media source that is streaming the desired song or artist and will then transmit the URL for the media source of the scheduled program after completion of the one or more songs. The timeline server maintains a data record that the user has affirmatively changed programs, but also keeps track of the user's timeline and the upcoming program information. Therefore, the timeline server can easily switch back to the scheduled program. This association is preferably stored in a cache at the timeline server or on the user's device in order to minimize delay.

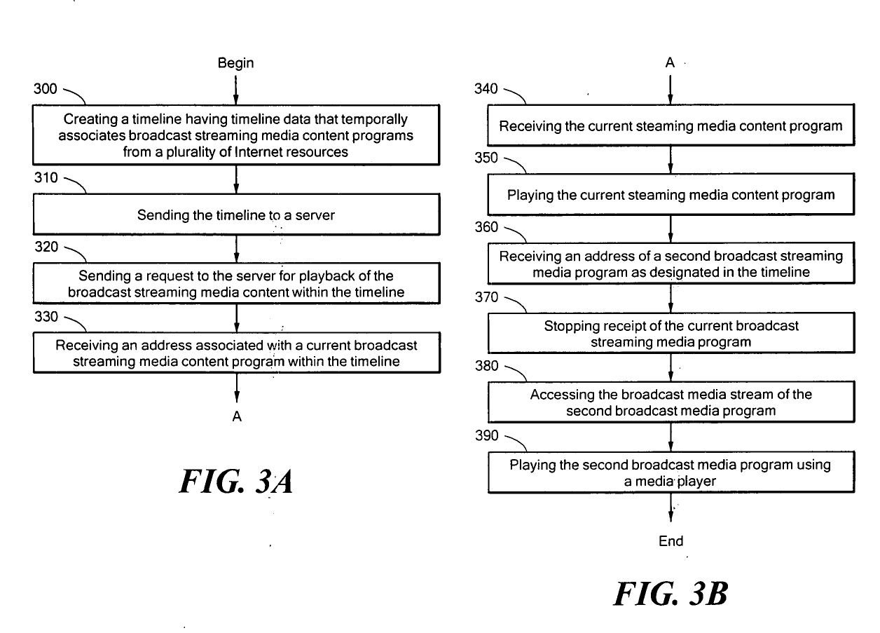

FIG. 3A is a flow chart of events that occur on a user's device during the creation of and use of a timeline for streaming broadcast media to the user. First, the user accesses the timeline web page by selecting or typing the timeline webpage's URL into a web browser associated with the user's device. If the user has already created an account the user will either be recognized by the server via a cookie or can log into the website either actively or passively (using cookies) and will be presented with all of the user's previously created timeliness The user may then create a new timeline by selecting either complete programs or portions of programs from schedules of broadcast streaming media content from the plurality of different media sources 300. The web page preferably includes scripts that provide either pull down/pop up menus or drag and drop functionality. Additionally, the script can maintain the timeline in a predetermined protocol format for transmission. The created timeline includes data that temporally associates a sequence of broadcast streaming media program titles from different media sources. After the timeline is completed, the script within the webpage takes all of the timeline data and transmits the timeline to the timeline server 310.

When the user wishes to begin accessing one of the created timelines, the user will indicate this through selection of a button object on the webpage, such as a ‘play’ button as shown in FIG. 4. It should be recognized from FIG. 4 that the user can create multiple timelines and can switch between timelines simply by selection of the play button associated with each timeline.

The play command causes the JavaScript within the web page to transmit to the timeline server the user's ID along with an identifier of the desired user timeline 320. This may be done using an XML HTTP request object. As shown in FIG. 4, the user may select play for the “At Work Favorites” timeline and the user ID and the ID for the “At Work Favorites” timeline is transmitted. In response to this transmission, the user's device will receive one or more addresses associated with the timeline as well as summary information about the timeline, such as the start time of the next program 330. If it is presently 10 am on Tuesday, the user device will receive the URL associated with the “Top 100 Countdown.” The receipt of the URL by the Web Browser will cause the JavaScript to either open a new Web Browser window framed within a page of the site with the URL or cause a media player or embedded java media player to begin receipt of the stream from the URL 340 as shown in FIG. 3B.

After receiving the broadcast streaming media, the media player will begin playing the streaming media content 350. At an appropriate time as identified in the timeline, JavaScript or a similar scripting language on the user's device will request from the timeline server an address of a second broadcast streaming media program as well as additional information about the timeline including the start time of the next program 360. In certain embodiments, the webpage includes a JavaScript timer that determines when the first broadcast is about to end using the present time clock signal originally received from the timeline server. The JavaScript, Ajax or similar script may query the timeline server and confirm that a switch between broadcasts should occur. Thus, timing information is updated from a central location. The media player/java player will terminate the stream of the current broadcast stream 370 and will access the broadcast media stream based upon the received address from the timeline server 380. As previously indicated, the timeline server 380 may provide one or more URL addresses to the user's device. If the timeline server 380 provides more than one address, a JavaScript within the webpage can automatically cause the switch between addresses without requiring additional communication with the timeline server. The java player will then begin to decode and play the second broadcast media program 390.

In certain embodiments, the JavaScript on the web page as displayed on the user's device may receive the entire time line and all of the URL's for the broadcast streaming media content from the timeline server in response to the selection of the play button for a timeline. In one embodiment, the JavaScript within the web page would include timing code for identifying the present time. In another embodiment, the timeline server provides the user's device the current time. The JavaScript would then identify the program associated with the present time by analyzing the timeline. The JavaScript would then cause the URL associated with the program for the current time within the timeline to be passed to the media player. The media player would then access the broadcast media stream associated with the URL. A JavaScript within the web page would keep track of the time either using the internal clock of the user's device or preferably relying on a received clock time from the timeline server. Thus, the user's browser would know when the presently playing broadcast should end and the JavaScript will cause the URL to be passed to either the embedded Java player or the external media player at the appropriate start time for the next broadcast program listed in the user's timeline sequence. Thus, much of the functionality that is performed by the server in other embodiments described above, such as keeping track of the time and causing transmission of the URL for a new broadcast at the properly scheduled time may be performed by scripts within the webpage. It is also contemplated that the timeline may be stored in a file on the user's device. In such an embodiment, there would be no need to access the timeline server after the creation of a timeline when playback was desired, since all of the information would be stored on the user's device.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an embodiment of the present invention, predominantly all of the reordering logic may be implemented as a set of computer program instructions that is converted into a computer executable form, stored as such in a computer readable medium, and executed by a microprocessor within the array under the control of an operating system.

Computer program logic implementing all or part of the functionality previously described herein may be embodied in various forms, including, but in no way limited to, a source code form, a computer executable form, and various intermediate forms (e.g., forms generated by an assembler, compiler, networker, or locator.) Source code may include a series of computer program instructions implemented in any of various programming languages (e.g., an object code, an assembly language, or a high-level language such as FORTRAN, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL.)

While the invention has been particularly shown and described with reference to specific embodiments, it will be understood by those skilled in the art that various changes in form and detail may be made therein without departing from the spirit and scope of the invention as defined by the appended clauses. As will be apparent to those skilled in the art, techniques described above for panoramas may be applied to images that have been captured as non-panoramic images, and vice versa.

Embodiments of the present invention may be described, without limitation, by the following clauses. While these embodiments have been described in the clauses by process steps, an apparatus comprising a computer with associated display capable of executing the process steps in the clauses below is also included in the present invention. Likewise, a computer program product including computer executable instructions for executing the process steps in the clauses below and stored on a computer readable medium is included within the present invention.

I claim:

1. A method for controlling broadcast streaming media to a user's Internet device, the broadcast streaming media being publicly accessible through resources on the Internet, the method comprising:
receiving a timeline temporally associating broadcast streaming media programs from a plurality of Internet resources;
identifying an address associated with a broadcast streaming media content program from the timeline;
sending across the Internet the address of the broadcast streaming media program to the user's Internet device.

2. The method according to claim 1 wherein the resources are located on a website.

3. The method according to claim 1 wherein the Internet resources include worldwide web resources.

4. The method according to claim 3 wherein the worldwide web resources include web pages.

5. The method according to claim 4 wherein the address is a web address.

6. The method according to claim 5, wherein the web address is a URL.

7. The method according to claim 1, further comprising:
storing the timeline data in memory associated with a user identifier.

8. The method according to claim 7 further comprising:
receiving a user identifier.

9. The method according to claim 1 wherein the timeline data associates broadcast streaming media content programs from a plurality of different media sources with designated broadcast times.

10. The method according to claim 1 wherein each broadcast streaming media program is a temporal subset of an audio stream.

11. The method according to claim 1 further comprising:
obtaining address information from a database for the broadcast streaming media programs within the timeline.

12. The method according to claim 1 further comprising:
storing timeline data for the timeline in a data structure that associates each streaming media content program with an address.

13. The method according to claim 12 wherein the data structure is a database.

14. The method according to claim 1 further comprising:
receiving a request for an address from the timeline.

15. The method according to claim 1, further comprising:
receiving current schedule information from a media source; and comparing the streamed media content program for a designated time to the current schedule information.

16. The method according to claim 16, further comprising:
if the current schedule information differs from the broadcast streaming media program for a designated time, locating an alternative streamed media content program.

17. A method for accessing streaming media on a user's Internet device, the streaming media being publicly accessible through resources on the Internet, the method comprising: creating a timeline having timeline data that temporally associates broadcast streaming media programs from a plurality of Internet resources;
sending the timeline to a server;
sending a request to the server for playback of the broadcast streaming media within the timeline;
receiving an address associated with a current broadcast streaming media program within the timeline.

18. The method according to claim 17, further comprising:
receiving the current streaming media content program; and
playing the current streaming media content program.

19. The method according to claim 18, in response to a new start time as designated in the timeline for a second broadcast streaming media program, stopping receipt of the current broadcast streaming media program.

20. The method according to claim 18, further comprising:
receiving an address of the second broadcast streaming media program as designated in the timeline.

21. The method according to claim 20, further comprising:
ending playback of the current broadcast streaming media program.

22. The method according to claim 21, further comprising:
receiving the second broadcast streaming media program; and
playing the second broadcast streaming media program.

22. A system for scheduling broadcast streaming media for playback, the system comprising:
a user device creating a timeline for a user having timeline data that temporally associates broadcast streaming media from a plurality of media sources;
a server receiving a request for access to a user's timeline from the user device and in response sending the user device an address of a current broadcast streaming program from the timeline;
wherein the user device transmits the user's timeline to the server and the server stores the timeline for latter retrieval and the in response to receiving the address, the user's device accesses a broadcast stream from a media source associated with the address.

23. A computer program product on a computer-readable medium for use with computer having computer code thereon for controlling broadcast streaming media to a user's Internet device, the broadcast streaming media being publicly accessible through resources on the Internet, the computer code comprising:
computer code for receiving a timeline temporally associating broadcast streaming media programs from a plurality of Internet resources;
computer code for identifying an address associated with a broadcast streaming media content program from the timeline;
computer code for sending across the Internet the address of the broadcast streaming media program to the user's Internet device.

24. The computer program product according to claim 23 wherein the resources are located on a website.

25. The computer program product according to claim 23 wherein the Internet resources include worldwide web resources.

26. The computer program product according to claim 25 wherein the worldwide web resources include web pages.

27. The computer program product according to claim 26 wherein the address is a web address.

28. The computer program product according to claim 27, wherein the web address is a URL.

29. The computer program product according to claim 23, further comprising:
computer code for storing the timeline data in memory associated with a user identifier.

30. The method according to claim 29 further comprising:
computer code for receiving a user identifier.

31. The computer program product according to claim 23 wherein the timeline data associates broadcast streaming media content programs from a plurality of different media sources with designated broadcast times.

32. The computer program product according to claim 2333 wherein each broadcast streaming media program is a temporal subset of an audio stream.

33. The computer program product according to claim 23 further comprising:
computer code for obtaining address information from a database for the broadcast streaming media programs within the timeline.

34. The computer program product according to claim 23 further comprising:
computer code for storing timeline data for the timeline in a data structure that associates each streaming media content program with an address.

35. The method according to claim 34 wherein the data structure is a database.

36. The computer program product according to claim 23 further comprising:
computer code for receiving a request for an address from the timeline.

37. The computer program product according to claim 23, further comprising:
computer code for receiving current schedule information from a media source; and
comparing the streamed media content program for a designated time to the current schedule information.

38. The computer program product according to claim 37, further comprising:
computer code for locating an alternative broadcast streaming media program if the current schedule information differs from the broadcast streaming media program for a designated time.

39. A computer program product on a computer-readable medium having computer code thereon for use with a computer for accessing streaming media on a user's Internet device, the streaming media being publicly accessible through resources on the Internet, the computer code comprising:
computer code for creating a timeline having timeline data that temporally associates broadcast streaming media programs from a plurality of Internet resources;
computer code for sending the timeline to a server;
computer code for sending a request to the server for playback of the broadcast streaming media within the timeline;
computer code for receiving an address associated with a current broadcast streaming media program within the timeline.

40. The computer program product according to claim 39, further comprising:
computer code for receiving the current streaming media content program; and
computer code for playing the current streaming media content program.

41. The computer program product according to claim 39, in response to a new start time as designated in the timeline for a second broadcast streaming media program, computer code for stopping receipt of the current broadcast streaming media program.

42. The computer program product according to claim 39, further comprising:
computer code for receiving an address of the second broadcast streaming media program as designated in the timeline.

43. The method according to claim 42, further comprising:
computer code for ending playback of the current broadcast streaming media program.

44. The computer program product according to claim 43, further comprising:
computer code for receiving the second broadcast streaming media program; and
computer code for playing the second broadcast streaming media program.
